(19) United States
(12) Patent Application Publication
(10) Pub. No.: US 2013/0229592 A1
(43) Pub. Date: Sep. 5, 2013

(54) DISPLAY MODULE

(71) Applicant: Yuan-Mo Li, Taoyuan County (TW)

(72) Inventor: Yuan-Mo Li, Taoyuan County (TW)

(73) Assignee: CHUNGHWA PICTURE TUBES, LTD., Taoyuan (TW)

(21) Appl. No.: 13/480,489

(22) Filed: May 25, 2012

(30) Foreign Application Priority Data
Mar. 2, 2012 (TW) 101203754

(51) Int. Cl. G02F 1/1333

(52) U.S. Cl. 349/58

(57) ABSTRACT

A display module includes a display panel, a backlight assembly, and a support frame. The support frame includes a bottom part, a sidewall, and a plurality of tenons. The sidewall and the bottom part are connected to form an accommodation space. The display panel and the backlight assembly are disposed in the accommodation space, and the display panel is disposed on the backlight assembly. Each of the tenons has a height and is disposed on a top part of the sidewall. Besides, each of the tenons is extended inward by a distance, so as to cover a portion of periphery of the display panel and wedge the display panel. The bottom part, the sidewall, and the tenons are integrally formed.

### CROSS-REFERENCE TO RELATED APPLICATION

This application claims the priority benefit of Taiwan application serial no. 101203754, filed on Mar. 2, 2012. The entirety of the above-mentioned patent application is hereby incorporated by reference herein and made a part of this specification.

### BACKGROUND OF THE INVENTION

1. Field of Invention

The invention generally relates to a display module, and more particularly, to a display module having tenons.

2. Description of Related Art

With great advance in techniques of manufacturing opto-electronics and semiconductor devices, flat panel displays have been vigorously developed. Among the flat panel displays, liquid crystal displays (LCDs) characterized by low operating voltage, free of harmful radiation, light weight, and small and compact size are gradually replacing conventional cathode ray tube (CRT) displays and have become mainstream display products.

In general, an LCD module includes a backlight assembly and a LCD panel. The LCD panel is disposed on the backlight assembly, and the backlight assembly includes a light guide plate (LGP) and a light source and serves as a backlight source for the LCD panel to display images. The backlight assembly and the LCD panel are often fixed by iron frames or tapes and assembled to each other to form an LCD module. However, due to the iron frames or the tapes applied for assembling the backlight assembly and the LCD panel to form the LCD module, the entire thickness of the LCD module is unlikely to be reduced, and the manufacturing costs are increased.

On the other hand, a cover lens is often disposed on a panel (e.g., a touch display panel), and the cover lens is, in most cases, adhered onto the entire surface of the touch display panel with use of an adhesive. Specifically, in order to adhere the cover lens to the panel, an adhesive is often coated onto the entire surface of the cover lens, and the panel and the cover lens are then aligned and adhered to each other. A pressing stress is exerted on the cover lens by a machine, so as to adhere the panel and the cover lens. At last, the adhesion process is completed through vacuum suction, UV curing, and so on. In the event that the pressing stress exerted by the machine is not well controlled, the thickness of the adhesive does not remain consistent, which leads to poor yield of the finish product and waste of the adhesive material.

### SUMMARY OF THE INVENTION

The invention is directed to a display module, wherein a display panel and a backlight assembly of which are assembled to each other by tenons.

The invention is directed to a display module, wherein a display panel and a backlight assembly of which are assembled to each other by tenons. Besides, the thickness of an adhesive layer between a cover lens and a display panel is monitored.

In the invention, a display module that includes a display panel, a backlight assembly, and a support frame is provided. The support frame includes a bottom part, a sidewall, and a plurality of tenons. The sidewall and the bottom part are connected to form an accommodation space. The display panel and the backlight assembly are disposed in the accommodation space, and the display panel is disposed on the backlight assembly. Each of the tenons has a height and is disposed on a top part of the sidewall. Besides, each of the tenons is extended inward by a distance, so as to cover a portion of periphery of the display panel and wedge the display panel. The bottom part, the sidewall, and the tenons are integrally formed.

In the invention, another display module is provided. The display module includes a display panel, a backlight assembly, a support frame, a cover lens, and an adhesive layer. The support frame includes a bottom part, a sidewall, and a plurality of tenons. The sidewall and the bottom part are connected to form an accommodation space. The display panel and the backlight assembly are disposed in the accommodation space, and the display panel is disposed on the backlight assembly. Each of the tenons has a height and is disposed on a top part of the sidewall. Besides, each of the tenons is extended inward by a distance, so as to cover a portion of periphery of the display panel and wedge the display panel. The bottom part, the sidewall, and the tenons are integrally formed. The cover lens is disposed on and in contact with the tenons to cover the display panel. A space between the cover lens and the display panel is filled with the adhesive layer, and the adhesive layer has a thickness substantially equal to the height.

According to an embodiment of the invention, the height ranges from about 0.1 mm to about 0.25 mm.

According to an embodiment of the invention, a material of the bottom part, the sidewall, and the tenons includes plastic.

According to an embodiment of the invention, the tenons are disposed on opposite sides of the top part of the sidewall.

According to an embodiment of the invention, a shape of the tenons includes a wedge-like shape, a rectangular shape, or a triangular shape.

Based on the above, in the display module of the invention, the display panel and the backlight assembly are fixed together with use of the tenons of the support frame. According to an embodiment of the invention, the cover lens is adhered to the display panel by the adhesive layer, and the cover lens is configured on the tenons. By controlling the height of each tenon, the distance between the cover lens and the display panel can be monitored, and so can the thickness of the adhesive layer be monitored. As a result, the design margin of the manufacturing conditions for coating the cover lens with the adhesive layer can be improved, and the yield of the display module can also be ameliorated.

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1A is a schematic top view illustrating a display module according to an embodiment of the invention.

FIG. 1B is a schematic cross-sectional view taken along line I-I′ depicted in FIG. 1A.

FIG. 2A is a schematic top view illustrating a display module according to an embodiment of the invention.

FIG. 2B is a schematic cross-sectional view taken along line I-I′ depicted in FIG. 2A.

### DETAILED DESCRIPTION OF DISCLOSED EMBODIMENTS

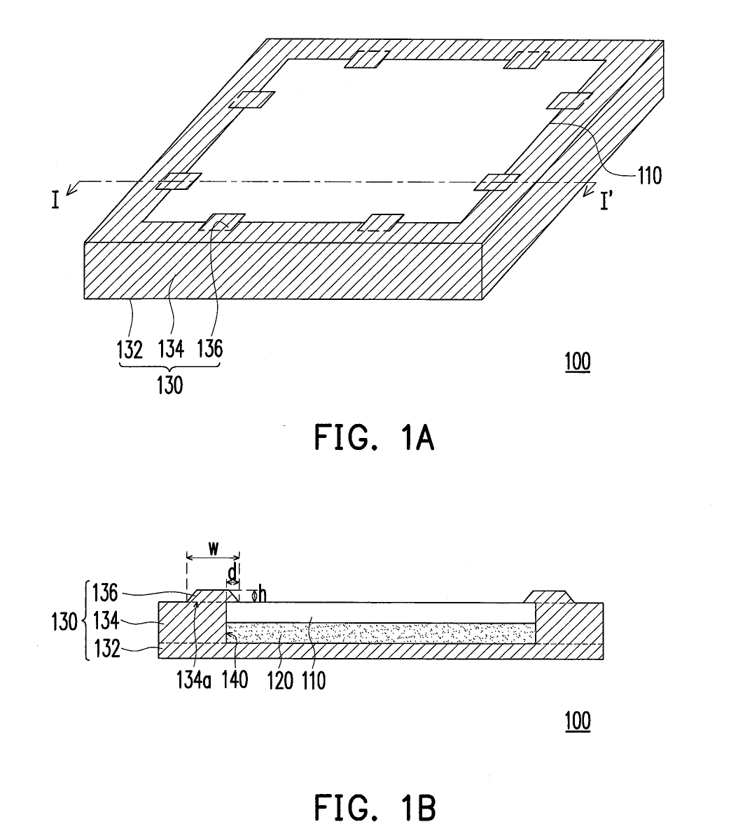

FIG. 1A is a schematic top view illustrating a display module according to an embodiment of the invention. FIG. 1B is a schematic cross-sectional view taken along line I-I′ depicted in FIG. 1A. With reference to FIG. 1A and FIG. 1B, the display module 100 described in the present embodiment includes a display panel 110, a backlight assembly 120, and a support frame 130.

The support frame 130 includes a bottom part 132, a sidewall 134, and a plurality of tenons 136, and the bottom part 132, the sidewall 134, and the tenons 136 are integrally formed. According to an embodiment of the invention, a material of the bottom part 132, the sidewall 134, and the tenons 136 includes plastic, for instance. A method of forming the bottom part 132, the sidewall 134, and the tenons 136 includes injection molding, for instance. The sidewall 134 and the bottom part 132 are connected to form an accommodation space 140. The display panel 110 and the backlight assembly 120 are disposed in the accommodation space 140, and the display panel 110 is disposed on the backlight assembly 120. In the present embodiment, the display panel 110 is a liquid crystal display panel, for instance. The display panel 110 is disposed on a light emitting side of the backlight assembly 120. According to the present embodiment, the backlight assembly 120 may be an optical film, a light guide plate, and so on. Hence, the backlight module is exemplarily constituted by the backlight assembly 120 and the support frame 130.

Each of the tenons 136 has a height h and is disposed on a top part 134a of the sidewall 134. Besides, each of the tenons 136 is extended inward by a distance d, so as to cover a portion of periphery of the display panel 110 and wedge the display panel 110. To be more specific, the distance between the top part 134a of the sidewall 134 and the bottom part 132 is designed according to the total thickness of the display panel 110 and the backlight assembly 120, such that the tenons 136 extended inward are substantially wedged to a portion of the periphery of the display panel 110. Besides, the tenons 136 cover a portion of periphery of the display panel 110. Thereby, the display panel 110 and the backlight assembly 120 are fixed into the accommodation space 140 by the tenons 136. In the present embodiment, the tenons 136 are configured on opposite sides of the top part of the sidewall 134, for instance. Namely, the tenons 136 exemplarily cover the periphery of opposite sides of the display panel 110, so as to cover the display panel 110 symmetrically. In an embodiment of the invention, the backlight assembly 120 is placed on the bottom part 132 of the support frame 130, such that an accommodation space (not shown) exists between the backlight assembly 120 and the tenons 136. The display panel 110 is then lodged into the accommodation space.

The height h of each of the tenons 136 is substantially the same. According to the present embodiment, the height h of each tenon 136 ranges from about 0.1 mm to about 0.25 mm, for instance. A width w, the extended distance d, the shape, the number, and the location of each tenon 136 may be changed based on actual demands, which should not be construed as limitations to the invention. For instance, in the present embodiment, the shape of the tenons 136 may be a wedge-like shape (as shown in FIG. 1B), a rectangular shape, or a triangular shape, for instance.

In the present embodiment, the display panel 110 and the backlight assembly 120 are fixed into the support frame 130 by the tenons 136 of the support frame 130. That is to say, the fixing of the display panel 110 and the backlight assembly 120 does not require any iron frames, tapes, or additional fixing components but the tenons 136 configured on the top part 134a of the sidewall 134 of the support frame 130. Since the bottom part 132, the sidewall 134, and the tenons 136 are integrally formed, the support frame 130 as a whole has a relatively thin thickness, light weight, and favorable mechanical strength. As a result, the display module 100 can be characterized by compactness and satisfactory yield.

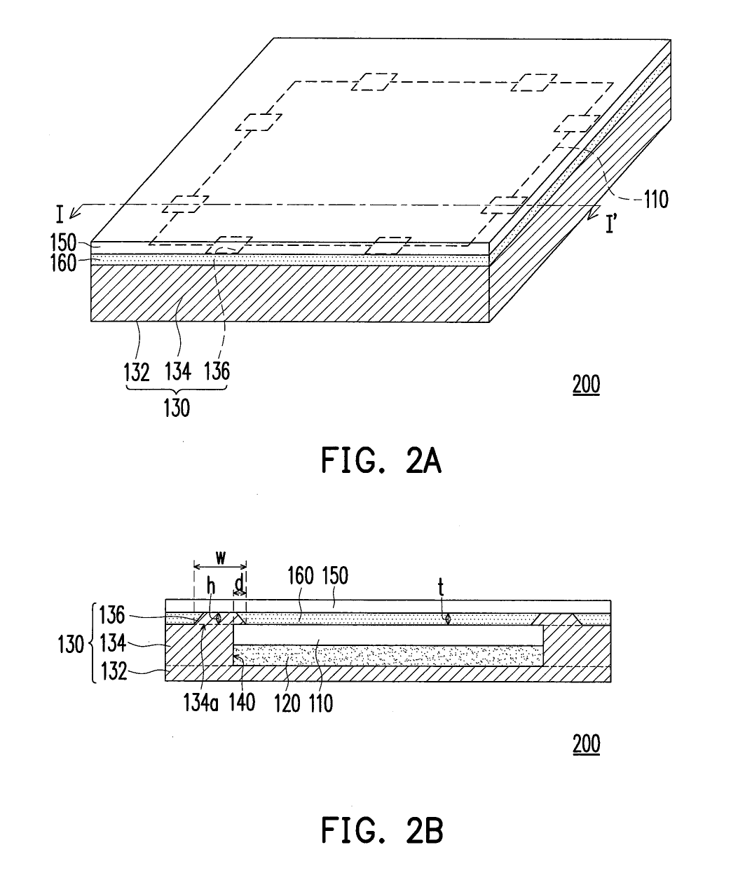

FIG. 2A is a schematic top view illustrating a display module according to an embodiment of the invention, and FIG. 2B is a schematic cross-sectional view taken along line I-I′ depicted in FIG. 2A. With reference to FIG. 2A and FIG. 2B, the display module 200 described in the present embodiment includes a display panel 110, a backlight assembly 120, a support frame 130, a cover lens 150, and an adhesive layer 160. The display panel 110, the backlight assembly 120, and the support frame 130 described herein are substantially the same as those described in the embodiment shown in FIG. 1A and FIG. 1B, and therefore no further description is provided hereinafter.

The cover lens 150 is disposed on and in contact with the tenons 136 to cover the display panel 110. An adhesive layer 160 is disposed between the cover lens 150 and the display panel 110, and the adhesive layer 160 has a thickness t substantially equal to the height h. According to the present embodiment, a method of disposing the cover lens 150 onto the display panel 110 includes cleaning the surface of the cover lens 150 and the upper surface of the display panel 110 and coating the cleaned surface of the cover lens 150 with an adhesive material. The cover lens 150 and the display panel 110 are then aligned to each other, such that the surface of the cover lens 150 coated with the adhesive material faces the display panel 110. Thereafter, the cover 150 is attached to the display panel 110 by the tenons 136, so as to cover the display panel 110. Here, the cover lens 150 is disposed on and in contact with the tenons 136. At this time, the space between the cover lens 150 and the display panel 110 is filled with the adhesive material, so as to form the adhesive layer 160. In the present embodiment, the adhesive layer 160 is made of an optical adhesive, for instance. The thickness t of the adhesive layer 160 is substantially the same as the height h of the tenons 136 and ranges from about 0.1 mm to about 0.25 mm, for instance.

In the present embodiment, the display panel 110 and the backlight assembly 120 are fixed into the support frame 130 by the tenons 136 of the support frame 130. That is to say, the fixing of the display panel 110 and the backlight assembly 120 does not require any iron frames, tapes, or additional fixing components but the tenons 136 configured on the top part 134a of the sidewall 134 of the support frame 130. Since the bottom part 132, the sidewall 134, and the tenons 136 are integrally formed, the support frame 130 as a whole has a relatively thin thickness, light weight, and favorable mechanical strength. As a result, the display module 100 can be characterized by compactness and satisfactory yield.

In the present embodiment, the cover lens 150 is in contact with the tenons 136, such that the cover lens 150 is configured on the display panel 110, and that the adhesive layer 160 can be formed in the space defined by the height h of each tenon 136. Namely, by controlling the height h of each tenon 136, the distance between the cover lens 150 and the display panel 110 can be monitored, and so can the thickness t of the adhesive layer 160 be monitored. Thereby, the adhesive layer 160 may have the controllable and substantially consistent thickness, and the issue of the overly small, large, or inconsistent thickness of the adhesive layer 160 can be precluded. In other words, if the tenons 136 are designed to have the appropriate height, the adhesive layer 160 can be made of the adhesive material in a predetermined amount. As such, the waste of the adhesive material can be prevented. On the other hand, the adhesive layer 160 is evenly distributed into the space defined by the height h of each tenon 136, and the adhesive layer 160 is configured between the cover lens 150 and the display panel 110. Therefore, the cover lens 150 and the display panel 110 may have no space therebetween, and the display panel 100 is allowed to have favorable optical display characteristics. As a result, the display module 100 described in the present embodiment may have satisfactory manufacturing margin and yield.

To sum up, in the display module of the invention, the display panel and the backlight assembly are fixed into the support frame by use of the tenons of the support frame. To be more specific, the tenons are extended from the sidewall of the support frame to the periphery of the display panel, and thus the display panel can be lodged into the accommodation space defined by the backlight assembly, the sidewall, and the tenons. Since the bottom part of the support frame, the sidewall of the support frame, and the tenons are integrally formed, the configuration of the tenons does not significantly increase the entire thickness of the support frame. Accordingly, the support frame is likely to have a relatively thin thickness, light weight, and favorable mechanical strength. As a result, the display module can be characterized by compactness and satisfactory yield.

According to an embodiment of the invention, the cover lens is in contact with the tenons, such that the cover lens is configured on the display panel, and that the adhesive layer can be formed in the space defined by the height of each tenon to adhere the cover lens to the display panel. Namely, by controlling the height of each tenon, the distance between the cover lens and the display panel can be monitored, and so can the thickness of the adhesive layer be monitored. Thereby, the adhesive layer may have the controllable and substantially consistent thickness, which not only prevents the waste of the adhesive material but also avoids the formation of space between the cover lens and the display panel. Accordingly, the display module may have satisfactory manufacturing margin, yield, and optical characteristics.

Although the invention has been described with reference to the embodiments thereof, it will be apparent to one of the ordinary skills in the art that modifications to the described embodiments may be made without departing from the spirit of the invention. Accordingly, the scope of the invention will be defined by the attached claims not by the above detailed description.

What is claimed is:

1. A display module comprising:
a display panel;
a backlight assembly; and
a support frame comprising:
a bottom part;
a sidewall connected to the bottom part to form an accommodation space, the display panel and the backlight assembly being disposed in the accommodation space, the display panel being disposed on the backlight assembly; and
a plurality of tenons, each of the tenons having a height and being disposed on a top part of the sidewall, each of the tenons being extended inward by a distance, so as to cover a portion of periphery of the display panel and wedge the display panel, wherein the bottom part, the sidewall, and the tenons are integrally formed.

2. The display module as recited in claim 1, wherein the height ranges from 0 1 mm to 0.25 mm.

3. The display module as recited in claim 1, wherein a material of the bottom part, the sidewall, and the tenons includes plastic.

4. The display module as recited in claim 1, wherein the tenons are disposed on opposite sides of the top part of the sidewall.

5. The display module as recited in claim 1, wherein a shape of the tenons includes a wedge-like shape, a rectangular shape, or a triangular shape.

6. A display module comprising:
a display panel;
a backlight assembly;
a support frame comprising:
a bottom part;
a sidewall connected to the bottom part to form an accommodation space, the display panel and the backlight assembly being disposed in the accommodation space, the display panel being disposed on the backlight assembly; and
a plurality of tenons, each of the tenons having a height and being disposed on a top part of the sidewall, each of the tenons being extended inward by a distance, so as to cover a portion of periphery of the display panel and wedge the display panel, wherein the bottom part, the sidewall, and the tenons are integrally formed;
a cover lens disposed on and in contact with the tenons to cover the display panel; and
an adhesive layer, a space between the cover lens and the display panel being filled with the adhesive layer, wherein the adhesive layer has a thickness substantially equal to the height.

7. The display module as recited in claim 6, wherein the height ranges from 0.1 mm to 0.25 mm.

8. The display module as recited in claim 6, wherein a material of the bottom part, the sidewall, and the tenons includes plastic.

9. The display module as recited in claim 6, wherein the tenons are disposed on opposite sides of the top part of the sidewall.

10. The display module as recited in claim 6, wherein a shape of the tenons includes a wedge-like shape, a rectangular shape, or a triangular shape.
